(19) United States
(12) Patent Application Publication
(10) Pub. No.: US 2026/0036365 A1
(43) Pub. Date: Feb. 5, 2026

(54) PROCESS AND APPARATUS FOR SEPARATING A GAS MIXTURE

(71) Applicant: L'Air Liquide, Société Anonyme pour I'Etube et I'Exploitation des Procédés Georges Claude, Paris (FR)

(72) Inventors: Jean-Baptiste CHAIX, Charenton-le-Pont (FR); Mathieu LECLERC, Paris (FR); Achraf HARBAL, Charenton-le-Pont (FR)

(21) Appl. No.: 19/273,958

(22) Filed: Jul. 18, 2025

(30) Foreign Application Priority Data
Jul. 31, 2024 (FR) FR2408456

(51) Int. Cl. F25J 3/04

(52) U.S. Cl. CPC F25J 3/04012; F25J 3/04181; F25J 2205/70

(57) ABSTRACT

A process for separating a gas mixture, a first item of equipment of the process is heated by a first flow of a first heat producer and supplies heat to a first fluid, the first flow of heat producer being heated upstream of the first item of equipment by a heat source, a second item of equipment of the process heats a second fluid while consuming heat, the heat originating from a second flow of the first heat producer heated by the heat source, which heats the second flow of the first heat producer up to an intermediate temperature lower than the second temperature, and by a heater downstream of the source, which heats the second flow of the first heat producer, which has been heated by the heat source, from the intermediate temperature up to a second temperature higher than the first temperature.

### CROSS REFERENCE TO RELATED APPLICATIONS

This application claims the benefit of priority under 35 U.S.C. § 119(a) and (b) to French Patent Application No. FR2408456, filed Jul. 31, 2024, the entire contents of which are incorporated herein by reference.

### BACKGROUND

The present invention relates to a process and to an apparatus for separating a gas mixture.

In particular, it relates to a process for separating a gas mixture, for example containing CO2 and at least one impurity that is lighter than CO2 and/or at least one impurity that is heavier than CO2, in which the mixture is separated by scrubbing and/or distillation and/or partial condensation and/or solidification, for example in a system of columns.

The gas mixture may be, for example, air or a mixture containing at least 30 mol % CO2 or at least 60% CO2, or even at least 90% CO2.

The process comprises a step of heating at least one of the elements of the separation apparatus using a circuit.

Processes for separating air or for capturing CO2 cryogenically most often comprise compression followed by drying before sending the pre-purified gas to a cryogenic part. This drying is conventionally carried out by adsorption: the impurities are adsorbed in one or more cylinders, while other cylinders in parallel are regenerating by means of a hot gas (TSA). The heat supplied to the regeneration gas may originate from steam or from electricity.

When steam is not available or too expensive (for example when capturing CO2 from smoke originating from a cement plant), and/or when electricity is also expensive, thermal integration can be considered in which the heat dissipated during the compression step is used to heat water, which itself then heats the regeneration gas.

CO2 capture processes also require heating at several different temperatures.

The invention proposed here makes it possible to optimize the costs of this type of system and to continue to heat an item of equipment to the required temperature even when a heat source fails.

### PRIOR ART

The use of an electric or steam heater for regenerating dryers is very conventional, being described in FR-A-2984474 and WO2019/127179.

For an air separation process, the use of a hot water network to heat nitrogen is known from EP-A-2873938 and U.S. Pat. No. 5,846,295. In EP-A-2873938, the compression heat heats the nitrogen via a water circuit up to 95° C. and an electric heater heats the nitrogen from 95 to 140° C.

In a variant, the nitrogen is divided in two, one part being heated by the water circuit and the other by the heater in order to reach the required temperature. Apart from regeneration, the compression heat is used to heat a building via the water circuit.

U.S. Pat. No. 5,846,295 and FR-A-2830463 describe similar processes.

It is known practice to install a heater on hot water circuits in order to achieve a sufficiently high temperature when another heat source that contributes to heating the water is not in operation (for example when starting up or stopping the rest of the unit). This heater may be electric or use steam, for example. This heater may be stopped during normal operation.

It is also known from FR-A-3116586 to use hot water to vaporize cryogenic purges originating from the cryogenic process before they are emitted or used in the process.

### SUMMARY

The invention makes it possible to minimize the number of items of equipment used to heat water, by grouping several functionalities within the same apparatus. According to one variant, the function of heating the hot water when another heat source is not in operation is grouped with the function of overheating the water for another item of equipment, for example the heat exchanger for heating the gas for regenerating the dryers.

The invention consists mainly in using a heater on the hot water network, which enables, in a first operating mode, water to be heated for an item of equipment when another heat source is not in operation and, in a second operating mode, water to be heated up to one temperature for this item of equipment and up to another temperature for another item of equipment. The heater may, for example, be an electric heater or a steam heater.

There are then different possible operating modes for this heater:
Normal operation: the water is heated by its one or more heat sources (the compressor of the unit, for example), but at least one of its consumers requires a higher temperature. In this case, the heater supplies heat solely for at least one user requiring a higher temperature. It is then necessary to install it on the branch dedicated to this at least one consumer in order to minimize the energy consumption of the system (compared with a configuration that would consist in heating the entire hot water cycle).

This is particularly the case for CO2 capture units or air separation units, which require a high-temperature heat source for regenerating their dryers. It is not necessary to continuously heat the gas for regenerating the dryers (for example during the cooling phase).

Then, not only can the heater be switched off during this phase, but it is also necessary to remove excess heat from the hot water system (this hot water flow is neither heated in the heater nor used for regenerating the dryers). For this purpose, a dedicated cooler (atmospheric heat exchanger or cooling-water heat exchanger for example) known to a person skilled in the art is used.
Starting up: when hot water is required before starting up the heat sources that make it possible to generate this hot water, the heater will supply the necessary heat. This is particularly the case for CO2 capture units that require the treated gas to be heated before it is compressed (in particular at the outlet of the scrubbing column); whereas it is this same compression that supplies, in normal operation, the heat required to heat the hot water.
Stopping: when the heating function is required when the heat sources are stopped, the heater will heat the hot water system. This is particularly the case for CO2 capture units that require the vaporization of the purges of the cryogenic process while the compressors are stopped.

Thus, in the stopping or starting-up phase, when the heat sources are stopped, the low-temperature hot water consumers will be supplied with hot water after the heater. In normal operation, the hot water for these users is taken directly before the heater. A set of bypass pipes is required to provide these two operating modes.

However, low-temperature hot water consumers that are in operation only when the heat sources are also in operation are always supplied with hot water before the heater. This does not require an additional set of bypass pipes.

According to one subject of the invention, provision is made for a process for separating a gas mixture, for example containing CO2 and at least one impurity that is lighter than CO2 and/or at least one impurity that is heavier than CO2, in which the mixture is separated by scrubbing and/or distillation and/or partial condensation and/or solidification in a separation system, for example a system of columns and
i) a first item of equipment of the process is heated by a first flow of a first heat producer and supplies heat to a first fluid originating from or intended for the separation system, the first flow of heat producer being heated upstream of the first item of equipment by a heat source, which is at least one cooler of a compressor that compresses at least part of the gas mixture or a gas produced by separating the gas mixture, which heats the first flow of heat producer up to a first temperature, the first flow of heat producer passing through an open first valve and reaching the first item of equipment at the first temperature
ii) a second item of equipment of the process heats, optionally intermittently, a second fluid originating from or intended for the separation system while consuming heat, the heat originating from a second flow of the first heat producer heated by the heat source, which heats the second flow of the first heat producer up to an intermediate temperature lower than the second temperature, and by a heater downstream of the source, which heats the second flow of the first heat producer, which has been heated by the heat source, from the intermediate temperature up to a second temperature higher than the first temperature and being prevented from circulating to the first item of equipment by a closed second valve and by passing through an open third valve in order to reach the second item of equipment, and
iii) if, preferably only if, the heat source is not available, the heater heats a flow of the first heat producer up to the first temperature and the flow heated by the heater is sent at the first temperature to the first item of equipment, by passing through the open second valve.

According to other optional aspects:
a gas is separated in a temperature or pressure swing adsorption unit producing the gas mixture and a regeneration gas for the adsorption unit consisting of the second fluid originating from or intended for the separation system is heated by the second item of equipment;
the first item of equipment vaporizes at least one liquid, for example a purge liquid, drawn off from at least one column of the system of columns, this liquid being a first fluid originating from or intended for the separation system;
the first item of equipment operates during normal operation of the process for separating the gas mixture and during special operation of the process (for example starting up);
the second item of equipment operates intermittently during normal operation of the process for separating the gas mixture and is operated intermittently during special operation of the process (for example starting up);
the gas mixture is purified by adsorption in an adsorption unit upstream of the separation and the adsorption unit is regenerated by the second fluid;
the second item of equipment operates permanently during normal operation of the process for separating the gas mixture and is operated permanently during special operation of the process (for example starting up);
the gas mixture is purified of mercury in a mercury purification unit and the second fluid is a gas intended for the mercury purification of the process of separating the gas mixture;
part of the first heat-producing fluid heats an item of equipment that operates solely during normal operation of the separation process and not during special operation, for example starting up and/or stopping;
the compressor for the gas mixture operates during normal operation of the separation process and not during special operation, for example starting up and/or stopping;
the gas mixture is air;
the gas mixture contains at least 30 mol % CO2, or at least 60% CO2, or even at least 90% CO2;
at least part of the gas mixture is compressed in the compressor and is then separated in the separation system;
at least part of the gas mixture is separated in the separation system at a temperature of less than 0° C. or even less than −40° C.;
at least part of a gas produced by the separation system is compressed in the compressor;
at least part of a liquid produced by the separation system is vaporized to form a gas, which is compressed in the compressor;
the first heat producer cooled by the first and second items of equipment is returned to the heat source to be heated therein;
the first heat producer cooled by the first and second items of equipment is returned to the heat source to be heated therein after a cooling step downstream of the first and second items of equipment;
the gas mixture contains CO2 and NO_{X}, the column is a scrubbing column, the bottom liquid of which is enriched in NO_{X} relative to the gas mixture, and the bottom liquid is vaporized in the first item of equipment;
the first temperature is between 90 and 120° C. and/or the second temperature is between 150 and 170° C.;
the second temperature is at least 30° C. higher, preferably at least 50° C. higher, than the first temperature;
if, preferably only if, the heat source is not available, all of the flow heated by the heater is sent at the first temperature to the first item of equipment by passing through the open second valve;
if, preferably only if, the heat source is not available, all of the flow heated by the heater is sent at the first temperature to the first and second items of equipment by passing through the open second valve;
the heat source and/or the heater are/is an electric heating element;
the first heat producer is water or oil;
the source is a refrigerant of a compressor for the gas mixture or for a gas separated by adsorption in order to form the gas mixture or for a gas produced by separating the gas mixture.

According to one subject of the invention, provision is made for an apparatus for separating a gas mixture, for example containing CO2 and at least one impurity that is lighter than CO2 and/or at least one impurity that is heavier than CO2, comprising:
a) a separation system for separating the mixture by partial condensation and/or scrubbing and/or distillation and/or solidification
b) a first item of equipment, which is connected in order to heat a first fluid originating from or intended for the system of columns
c) a second item of equipment, which is connected in order to heat a second fluid originating from or intended for the system of columns
d) a heater
e) a heat source, which is at least one cooler of a compressor for at least part of the gas mixture or for a gas produced by the system of columns
f) a first valve, a second valve and a third valve
g) a pipe equipped with the first valve for sending a first flow (15) of a first heat-producing fluid heated by the heat source from the heat source to the first item of equipment without passing through the heater
h) a pipe for sending a second flow of the first heat-producing fluid heated by the heat source from the heat source to the heater and from the heater to the second item of equipment, the pipe in h) being equipped with the third valve downstream of the heater and upstream of the second item of equipment
i) a pipe for sending a flow of the first heat-producing fluid from the heater to the first item of equipment via the second valve connected downstream of the heater, upstream of the third valve and upstream of the first item of equipment and
j) means for initiating sending the flow of the first heat-producing fluid from the heater by opening the second valve to the first item of equipment, on the basis of a signal for stopping the operation of the source.

According to other optional aspects:
the apparatus comprises a cooler connected downstream of the first and second items of equipment for cooling the fluids that have heated these items of equipment;
the first valve is connected to the third valve via the second valve;
the apparatus comprises means for sending the first flow from the first item of equipment to the source and means for sending the second flow from the second item of equipment to the source;
the apparatus comprises a cooler connected upstream of the source and downstream of the first item of equipment and/or the second item of equipment for cooling the heat-producing fluid;
the apparatus comprises a purification unit upstream of the separation system for purifying the gas mixture of water and optionally of CO2.

### BRIEF DESCRIPTION OF THE DRAWINGS

The invention will be described in more detail with reference to the figures, in which:

FIG. 1 shows one part of a process according to the invention.

FIG. 2 shows a variant of FIG. 1.

FIG. 3 shows another part of the process according to the invention of FIG. 1 and FIG. 2.

### DETAILED DESCRIPTION OF PREFERRED EMBODIMENTS

FIG. 1 illustrates a heated-water distribution circuit, which can be operated according to the process of the invention for a process for separating a gas mixture. The water distribution circuit could be a circuit for distributing a different heat transfer substance, such as oil.

The circuit comprises at least:
an item of equipment B to be heated up to a first temperature and that operates during normal operation of the process for separating the gas mixture and during special operation of the process (for example starting up or stopping the process).
an item of equipment C to be heated intermittently up to a second temperature higher than the first temperature and that operates intermittently during normal operation of the process for separating the gas mixture and during special operation of the process (for example starting up or stopping the process).

The circuit may also comprise an item of equipment A to be heated up to the first temperature and that operates during normal operation of the process for separating the gas mixture but not during special operation of the process (for example starting up or stopping the process).

Heat sources H1, H2 may be coolers of a compressor for at least part of the gas mixture to be separated, before or after purification in order to remove water or of a compressor for a product of the gas separation of the gas mixture. The water is heated in at least one of the heat sources H1, H2, producing a flow 1 of hot water at a first temperature, for example at 110° C. In this example, the two heat sources H1, H2 are connected in parallel.

At least part of the gas mixture, which may be, for example, air or a mixture comprising at least 30 mol % CO2 or at least 60% CO2, or even at least 90% CO2, is compressed in a compressor, which may be the compressor having the coolers H1, H2 and is then separated by scrubbing and/or distillation and/or partial condensation.

Otherwise, the compressor having the coolers H1, H2 may be a compressor for a gas produced by the scrubbing and/or distillation and/or partial condensation and/or solidification of the gas mixture, for example nitrogen produced by separating air or separating a gas mixture containing at least 30 mol % CO2 and nitrogen.

In this particular case, the heated water is distributed to two users B, C and optionally to the user A.

The user B is an item of equipment requiring low-temperature heat in order to reach the first temperature (for example around 110° C.) in normal operation but also requiring a supply of heat, for a period in which the heat source H1, H2 is not operating, in order to reach the first temperature.

For example, if the heat source H1, H2 is a compressor for the gas mixture, for example air, a gas containing at least 30 mol % CO2, at least 60 mol % CO2, or even at least 90 mol % CO2, or a compressor for a gas produced by separating the gas mixture, as mentioned above, the heat source does not operate in the stopping or starting-up phase. However, during these periods, the user B has to receive water heated to the first temperature.

The user B heats a first fluid originating from or intended for the separation system, for example the system of columns.

The user B could, for example, be a vaporizer for purges of an apparatus for separation by distillation of air or of a gas mixture containing CO2 and at least one NOx. Thus, the first fluid is a liquid, in this case the purge liquid, originating from the separation system.

It could, however, be a heater for a gas mixture containing CO2 and at least one other component. Thus, the first fluid is a gas that is the gas mixture to be separated intended for the separation system.

The user C is an item of equipment requiring heat at a higher temperature than the first temperature (for example around 160° C.) and that operates intermittently.

For example, the user C may be the heater for regenerating a dryer (for example a temperature swing adsorption (TSA) dryer). The dryer may, for example, dry the gas mixture downstream of the compression producing heat or dry the gas mixture upstream of a compression of part of the gas mixture. The valve V3 is open during normal operation and the electric heater H3 makes it possible, during the heating phases of the regeneration, to reach the desired temperature by heating the water 7 already heated by the heat source H1, H2 in order to heat it from the first temperature to the second temperature (for example from 110 to 160° C.). Outside of these heating phases, the heater H3 is switched off and the hot water at the first temperature (˜110° C.) passes through the user C without any heat exchange taking place or else passes through a bypass path. The cooler R then makes it possible to remove this heat and to bring the low-temperature hot water from 110° C. to ˜30° C. The cooler R also makes it possible to balance the hot water network by removing the excess heat that is produced by the heat sources H1, H2 but not used by the users B, C.

The user C heats a second fluid originating from or intended for the separation system, for example the system of columns. In the example, the second fluid is the regeneration gas originating from the separation system and intended for the dryer.

Opening the valve V2 and closing the valves V1 and V3 makes it possible to guide the hot water heated by the electric heater H3 to the user B in the stopping or starting-up phase. Closing V2 and opening V1 allows low-temperature hot water to be used during normal operation.

The means for initiating sending the flow of the first heat-producing fluid from the heater H3 to the first item of equipment B on the basis of a signal for stopping the operation of the source H1, H2 are not illustrated.

During a nominal operating mode, a heat source formed by the heaters H1, H2 is operating and heats a first heat producer, for example water, 1 up to a first temperature (for example between 90 and 120° C., in this case 110° C.). This first heat producer is sent entirely to the first item of equipment to be heated B in order to supply it with the first heat producer at the first temperature. The first heat producer, for example this water, is cooled down to 60° C. in the item of equipment B and is returned by a pump P to the heat source, i.e. the heaters H1, H2. This first operating mode may be considered to be the nominal operating mode. According to this first mode, a heater H3 is not operating, even if the first heat producer can circulate through the heater H3 without being heated. A cooler R is used to cool the first heat producer originating from the items of equipment B and C in order to remove the excess heat. This cooler may be positioned solely so as to cool the heat producer originating from the items of equipment B and C and otherwise to cool the heat producer originating from the items of equipment A, B and C.

A pipe 6 connected to the pipe 5 upstream of the valve V1 is connected to the pipe 11. Said pipe makes it possible to return the first heat producer to the source in order to remove excess heat.

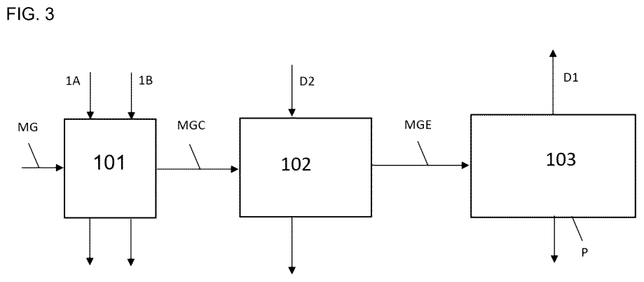

Next, two special operating modes are provided for particular cases: firstly, the case in which the heat source formed by the heaters is not operating and secondly, the case in which heat is required intermittently to supply at least one second item of equipment C at a second temperature higher than the first temperature. These special operating modes may correspond to the starting-up of the process of separating the gas mixture or to the stopping thereof, when the compressor 101 of FIG. 3 is not operating.

First of all, the case will be considered in which the heat source formed by the heaters H1, H2 is not operating (first special operating mode).

It is obvious that the use of two heaters in parallel is a special case and that the invention is applicable regardless of the heat source for the heat producer (a single heater, at least two heaters in series or in parallel).

A flow of a first heat producer, for example water, 1 circulates according to a first operating mode during which the heat source is, and therefore the heaters H1, H2 are, not operating. In the absence of the heat source H1, H2, the first heat producer, in this case water, is sent via the pipe 7 to the heater H3, which heats the water up to a first temperature, in this case 110° C. The item of equipment B requires heating even when the heat source H1, H2 is not operating.

The item of equipment B could, for example, be a vaporizer for purge liquid of an apparatus for separation by distillation of air or distillation of a gas mixture containing CO2 and at least one NOx.

It could, however, be a heater for a gas mixture containing CO2 and at least one other component. For example, the item of equipment B may be a heater for such a CO2 mixture upstream of a compressor.

In this case, the valve V1 is closed in order to close the pipe allowing the water to pass to the item of equipment B without passing through the heater H3. The valve V2 is open so that the water at 110° C. passes from the heater H3 into the pipe 13 and then into the pipe 15 in order to heat the item of equipment B.

The item of equipment C and the items of equipment A present are not heated.

The heater H3 is heated electrically or by a flow of steam.

The first heat producer is cooled from the first temperature down to a lower temperature in the item of equipment B and is returned to the heater H3 by the pump, passing through the heaters H1, H2 without being heated. In this case, the cooler is not operating.

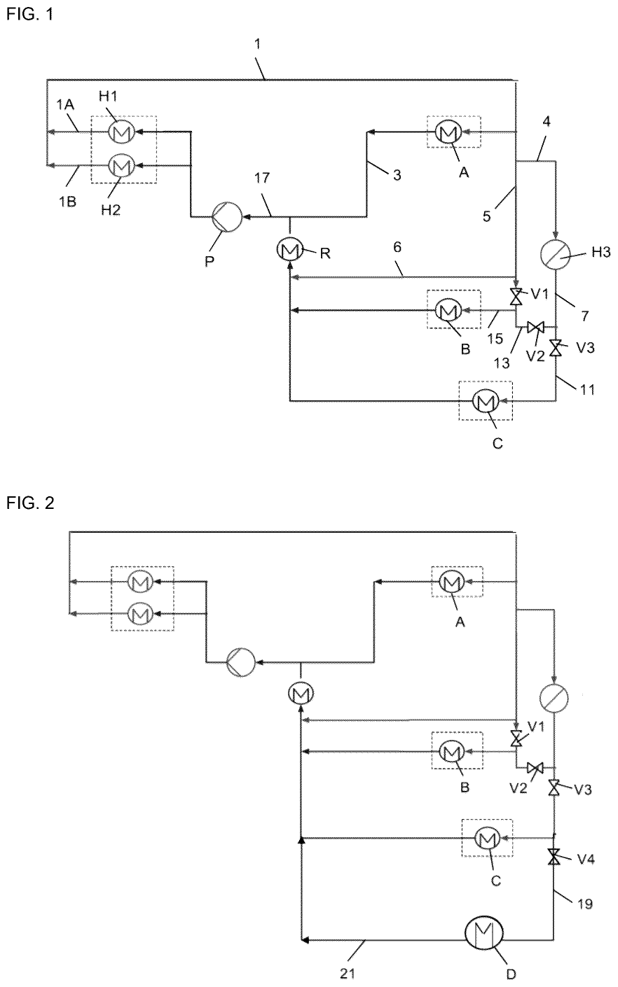

Next, the case will be considered in which an additional item of equipment D permanently requires water (nominal mode and special mode) at a temperature higher than the first temperature, for example between 150 and 170° C. This is the case in FIG. 2, which is a variant of FIG. 1, with only the item of equipment D and the pipe 19, 21 having been added.

According to a second operating mode, the heat source H1, H2 is operating and the flow of water is at 110° C. During this operating mode, the items of equipment C and D must be supplied with water at a second temperature higher than the first temperature and optionally the item of equipment B must also be supplied, but with water at the first temperature. Part of the flow 1 is sent via the pipe 7 to the heater H3 where the water is heated up to 160° C. and sent to the item of equipment C and/or the item of equipment D. The water passes to the item of equipment C via the open valve V3 and the pipe 23. The water passes to the item of equipment D via the open valve V4, the pipe 19 and then the pipe 21.

The item of equipment C is an item of equipment requiring heat at a higher second temperature (˜160° C.) than that (first temperature) which can be reached by the heat source H1, H2 alone and that operates intermittently.

For example, the user C may be the heater for a gas for regenerating a dryer (TSA). The valve V3 is open and the heater H3 makes it possible, during the heating phases of the regeneration, to reach the desired temperature.

Opening the valve V2 and closing the valves V1 and V3 makes it possible to guide the hot water heated by the heater H3 to this user in the stopping or starting-up phase. Closing V2 and opening V1 allows low-temperature hot water to be used during normal operation.

The user D is a heat exchanger making it possible to heat, for example, a gas intended for mercury purification of the process for separating the gas mixture.

A cooler R may make it possible to remove the excess heat and to bring the low-temperature hot water from 110° C. to around 30° C. The cooler R also makes it possible to balance the hot water network by removing the excess heat that is produced by the heat source but not used by the items of equipment.

The user A is an item of equipment requiring low-temperature heat (˜110° C.) in normal operation. It does not require a supply of heat while the heat source is not operating. The heat source may be a compressor for a gas mixture, for example a compressor for a process for separating the gas mixture by partial condensation and/or distillation. Such a compressor does not operate in certain periods, for example when the separation process is stopped or in a starting-up phase.

The user A is not necessarily present.

This invention can be combined with the concept of vaporizing the purges of the DeNOx column described in FR3147356A3.

FIG. 3 illustrates a process for separating a gas mixture according to the invention.

In particular, it relates to a process for separating a gas mixture MG, for example air or a mixture containing CO2 and at least one impurity that is lighter than CO2 and/or at least one impurity that is heavier than CO2, in which the air or the mixture is separated by scrubbing and/or distillation in a system of columns.

At least part of the gas mixture MG, which may be, for example, air or a mixture comprising at least 30 mol % CO2 or at least 60% CO2, or even at least 90% CO2, is compressed in a compressor 101 having the coolers H1, H2 and is then separated by scrubbing and/or distillation and/or partial condensation. The flows D1, D1′ are heated in the coolers H1, H2 and form the cycle fluid.

The gas mixture MGC compressed in the compressor 101 is then purified in an adsorption unit 102 in order to remove the water it contains and optionally other impurities to form a compressed and purified gas mixture MGCE, which is separated in the separation unit 103, for example by scrubbing and/or by distillation and/or by solidification and/or by partial condensation, producing at least one product P that can be compressed in a compressor (not illustrated).

This compressor may be used as a heat source for the heat-production cycle. The separation unit also produces purge liquid D1, originating from the separation unit 103. This liquid is heated by the item of equipment B of the preceding figures.

A gas D2 is used to regenerate the adsorption unit 102 and is heated cyclically by the item of equipment C.

The apparatus may comprise a unit for purifying of mercury the gas mixture supplied with a gas heated by the item of equipment D, if present.

The items of equipment C, D are not necessarily both present. For example, the item of equipment D may replace the item of equipment C in FIG. 1.

What is claimed is:

1. A process for separating a gas mixture in which the mixture is separated by scrubbing and/or distillation and/or partial condensation and/or solidification in a separation system, comprising
i) heating a first item of equipment of the process by a first flow of a first heat producer and thereby supplying heat to a first fluid originating from or configured for the separation system, the first flow of heat producer being heated upstream of the first item of equipment by a heat source, which is at least one cooler of a compressor that compresses at least part of the gas mixture or a gas produced by separating the gas mixture, which heats the first flow of heat producer up to a first temperature, the first flow of heat producer passing through an open first valve and reaching the first item of equipment at the first temperature,
ii) heating a second fluid originating from or configured for the separation system in a second item of equipment of the process system while consuming heat, the heat originating from a second flow of the first heat producer heated by the heat source, which heats the second flow of the first heat producer up to an intermediate temperature lower than the second temperature, and by a heater downstream of the source, which heats the second flow of the first heat producer, which has been heated by the heat source, from the intermediate temperature up to a second temperature higher than the first temperature and being prevented from circulating to the first item of equipment by a closed second valve and by passing through an open third valve in order to reach the second item of equipment, and
iii) heating a flow of the first heat producer up to the first temperature if the heat source is not available, and the flow heated by the heater is sent at the first temperature to the first item of equipment, by passing through the open second valve.

2. The process according to claim 1, wherein a gas is separated in a temperature or pressure swing adsorption unit producing the gas mixture and a regeneration gas for the adsorption unit consisting of the second fluid originating from or configured for the separation system is heated by the second item of equipment.

3. The process according to claim 1, wherein the first item of equipment vaporizes at least one liquid drawn off from at least one column of the system of columns, this liquid being a first fluid originating from or configured for the separation system.

4. The process according to claim 3, wherein the gas mixture contains CO2 and NO_{X}, the column is a scrubbing column, the bottom liquid of which is enriched in NO_{X} relative to the gas mixture, and the bottom liquid is vaporized in the first item of equipment.

5. The process according to claim 1, wherein the first temperature is between 90 and 120° C. and/or the second temperature is between 150 and 170° C.

6. The process according to claim 1, wherein if the heat source is not available, all of the flow heated by the heater is sent at the first temperature to the first item of equipment by passing through the open second valve.

7. The process according to claim 1, wherein the heat source and/or the heater are/is an electric heating element.

8. The process according to claim 1, wherein the first heat producer is water or oil.

9. The process according to claim 1, wherein the source is a refrigerant of a compressor for the gas mixture or for a gas separated by adsorption in order to form the gas mixture or for a gas produced by separating the gas mixture.

10. The process according to claim 1, wherein the fluid that has heated the first item of equipment and the fluid that has heated the second item of equipment are cooled in a common cooler.

11. An apparatus for separating a gas mixture, comprising:
a) a separation system for separating the mixture by partial condensation and/or scrubbing and/or distillation and/or solidification,
b) a first item of equipment (B), which is connected in order to heat a first fluid originating from or intended for the system of columns,
c) a second item of equipment, which is connected in order to heat a second fluid originating from or intended for the system of columns,
d) a heater,
e) a heat source, which is at least one cooler of a compressor for at least part of the gas mixture or for a gas produced by the system of columns,
f) a first valve, a second valve and a third valve,
g) a pipe equipped with the first valve for sending a first flow of a first heat-producing fluid heated by the heat source from the heat source to the first item of equipment without passing through the heater,
h) a pipe for sending a second flow of the first heat-producing fluid heated by the heat source from the heat source to the heater and from the heater to the second item of equipment, the pipe in step h) being equipped with the third valve downstream of the heater and upstream of the second item of equipment,
i) a pipe for sending a flow of the first heat-producing fluid from the heater to the first item of equipment via the second valve connected downstream of the heater, upstream of the third valve and upstream of the first item of equipment, and
j) means for initiating sending the flow of the first heat-producing fluid from the heater by opening the second valve to the first item of equipment, on the basis of a signal for stopping the operation of the source.

12. The apparatus according to claim 11, further comprising a cooler connected downstream of the first and second items of equipment for cooling the fluids that have heated these items of equipment.

13. The apparatus according to claim 11, wherein the first valve is connected to the third valve via the second valve.
